(19) United States
(12) Patent Application Publication
(10) Pub. No.: US 2022/0307377 A1
(43) Pub. Date: Sep. 29, 2022

(54) ROTORS FOR HIGH-PRESSURE COMPRESSORS AND LOW-PRESSURE TURBINE OF A GEARED TURBOFAN ENGINE AND METHOD FOR THE PRODUCTION THEREOF

(71) Applicant: MTU Aero Engines AG, Munich (DE)

(72) Inventor: Michael KASTENHUBER, Munich (DE)

(21) Appl. No.: 17/596,443

(22) PCT Filed: Jun. 8, 2020
(86) PCT No.: PCT/DE2020/000123

§ 371 Date: Dec. 10, 2021

(30) Foreign Application Priority Data
Jun. 14, 2019 (DE) 10 2019 208 666.7

(51) Int. Cl. F01D 5/28; C22C 19/05; C22C 19/07; C22C 21/00; C22C 27/04; C22C 16/00; F01D 5/06

(52) U.S. Cl. CPC F01D 5/28; C22C 19/056; C22C 19/07; C22C 21/003; C22C 27/04; C22C 16/00; F01D 5/06; F05D 2220/323; F05D 2230/25; F05D 2300/17; F05D 2230/11; F05D 2230/12

(57) ABSTRACT

A method for producing a rotary disk/blisk for a high-pressure compressor or a high-speed turbine and to a corresponding geared turbofan engine. The method involves providing a Ni base alloy comprising, in % by weight, 15.5-16.5 Cr, 14.0-15.5 Co, 4.75-5.25 Ti, 2.75-3.25 Mo. 2.25-2.75 Al, 1.00-1.50 W, as well as optionally 0.0250-0.0500 Zr, 0.0100-0.0200 B, 0.0100-0.0200 C, remainder Ni. The base alloy is shaped by forging to obtain a preform of the disk/blisk, the final contour thereof being produced by electrical discharge machining or electrochemical machining.

### BACKGROUND OF THE INVENTION

### Field of the Invention

The present invention relates to method for producing a rotary disk or a blisk for a high-pressure compressor or a low-pressure turbine of an aircraft engine, in particular of a geared turbofan engine, and to a geared turbofan engine for an aircraft having a fan and a low-pressure shaft with a low-pressure compressor and a low-pressure turbine, in which a reduction gear is arranged between the fan and the low-pressure shaft.

### Prior Art

Modern geared turbofan engines for aircraft are distinguished by the fact that they have lower fuel consumption and lower noise emissions than conventional engines owing to their efficiency. This is achieved by providing a reduction gear between the fan, which can also be referred to as a blower, and an engine shaft, which is driven by a turbine, for example the low-pressure turbine, and is connected to a compressor, for example the low-pressure compressor, and therefore the speed of the fan may be lower than the speed of this engine shaft and thus of the associated turbine and the associated compressor on the basis of the examination ratio. A turbine of this kind, which drives the fan and rotates faster than the latter, is also referred to as a “high-speed turbine”. On the other hand, higher rotational speeds of the respective turbine and of the respective compressor are thus possible. This has the effect, particularly in the region of the high-speed turbine, that the materials used there for the rotor disks and rotor blades have to meet high requirements with regard to strength, in particular high-temperature strength, and also creep strength and fatigue resistance. This is especially true because higher operating temperatures are simultaneously aimed for in the high-speed turbine, and high speeds of movement occur along the circular path of movement owing to the high speeds of revolution at the blade tips.

In the case of a high-speed turbine stage, values for the rotational speed Uₜᵢₚ at the blade tip are 300 m/s and more. In comparison, the maximum rotational speed Uₜᵢₚ in the case of turbine stages of conventional engines or in the case of turbine stages which are not high-speed turbine stages and run at the fan speed is 250 m/s.

Particularly for blisks (blisk: made-up word for bladed disk), on which the rotor blades and rotor disks are produced integrally in one piece, there are special requirements relating to the selection of materials since a balanced compromise must be found here for the different requirements on the disk material and the blade material.

Moreover, the materials used hitherto for this purpose require a high production outlay, especially for final machining, since, owing to the high strength of the materials used, high tool wear is to be expected or higher costs may occur for the machining.

### DISCLOSURE OF THE INVENTION

### Object of the Invention

It is therefore the object of the present invention to specify a corresponding material and a suitable production method for the production of rotary disks or blisks for a high-pressure compressor or a high-speed turbine, in particular a high-speed low-pressure turbine, preferably of an aircraft engine, in particular a geared turbofan engine. The corresponding material should permit high rotational speeds or speeds of revolution for the rotary disks or blisks with, at the same time, high operating temperatures, and it should be possible to carry out the method for producing the blisks or rotary disks in a simple and reliable manner.

### Technical Solution

This object is achieved by means of a method having the features of claim 1 and a geared turbofan engine having the features of claim 4. Advantageous embodiments form the subject matter of the dependent claims.

To produce a rotary disk or a blisk for a high-pressure compressor or a high-speed turbine of an aircraft engine and, in particular, of a geared turbofan engine, the present invention proposes to use a nickel base alloy which comprises 15.5% by weight to 16.5% by weight Cr, 14.0% by weight to 15.5% by weight Co, 4.75% by weight to 5.25% by weight Ti, 2.75% by weight to 3.25% by weight Mo, 2.25% by weight to 2.75% by weight Al, 1.00% by weight to 1.50% by weight W, optionally 0.0250% by weight to 0.0500% by weight Zr, optionally 0.0100% by weight to 0.0200% by weight B, optionally 0.0100% by weight to 0.0200% by weight C and the remainder Ni.

The nickel base alloy can optionally comprise 0.0250% by weight to 0.0500% by weight Zr and/or 0.0100% by weight to 0.0200% by weight B and/or 0.0100% by weight to 0.0200% by weight C.

“High-speed” can mean, in particular, that the rotary disk or blisk is designed and/or is suitable and/or intended for an An² greater than or equal to 4,000 m²/s², preferably greater than or equal to 4,500 m²/s², in particular greater than or equal to 5,000 m²/s² in the ADP range of the aircraft engine. In this context, “An²” is the annular area A at the outlet of the turbine stage having the respective rotary disk or blisk multiplied by the square of the rotational speed n. “ADP” stands for Aerodynamic Design Point, i.e. the operating state at cruising altitude, which is also referred to as the “cruise condition”. In conventional turbine stages which are not high-speed turbine stages, on the other hand, An² is significantly below 2,000 m²/s² in the ADP range.

The material defined above has been found to be highly suitable for the special requirements in a geared turbofan engine since, in addition to a high strength and, in particular, high-temperature strengths, it has excellent creep strength and fatigue resistance, and therefore an An² greater than or equal to 4,000 m²/s², preferably greater than or equal to 4,500 m²/s², in particular greater than or equal to 5,000 m²/s², is possible in the ADP range at operating temperatures greater than or equal to 650° C., in particular greater than or equal to 700° C.

Corresponding rotary disks or blisks can be produced in a simple manner by forging a casting block and final shaping by electrical discharge machining or electrochemical machining.

For the use of corresponding blisks in the high-pressure compressor of an aircraft engine, the blisks can be provided with a corrosion and/or erosion protection layer.

### BRIEF DESCRIPTION OF THE DRAWINGS

In the attached drawings, which are purely schematic,

FIG. 1 shows a sectional illustration through a geared turbofan engine, and

FIG. 2 shows a perspective illustration of a rotor in the form of a blisk.

### EXEMPLARY EMBODIMENTS

Further advantages, characteristics and features of the present invention will be apparent from the following detailed description of the exemplary embodiments. However, the invention is not restricted to these exemplary embodiments.

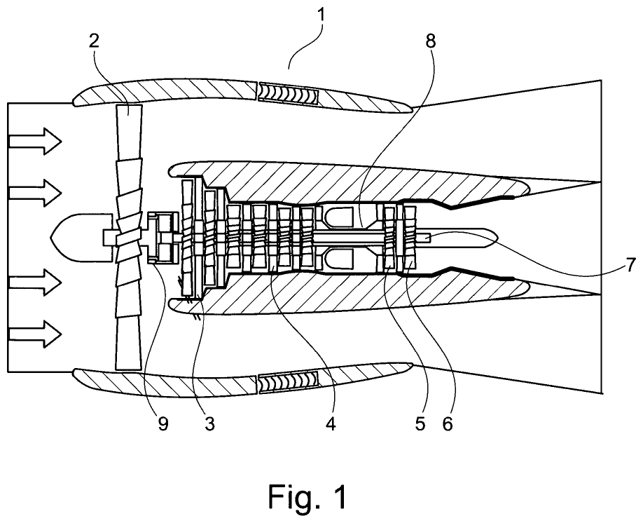

FIG. 1 shows a sectional illustration through a geared turbofan engine according to the present invention. The geared turbofan engine 1 comprises a “fan” 2, which is also referred to as a blower, as well as a low-pressure compressor 3, a high-pressure compressor 4, a high-pressure turbine 5 and a high-speed low-pressure turbine 6. The low-pressure compressor 3 and the low-pressure turbine 6 are arranged on a common low-pressure shaft 7, while the high-pressure compressor 4 and the high-pressure turbine 5 are arranged on a common high-pressure shaft 8. A reduction gear 9 is arranged between the low-pressure shaft 7 and the fan 2, reducing the rotational speed of the fan 2 with respect to the low-pressure shaft 7 in a certain reduction ratio, with the result that the rotational speed of the fan 2 is lower than the rotational speed of the low-pressure shaft 7 and thus of the low-pressure turbine 6 and of the low-pressure compressor 3. Low-pressure compressor 3, high-pressure compressor 4, high-pressure turbine 5 and low-pressure turbine 6 can have a plurality of rotors or stages in the form of rotary disks with rotor blades accommodated in the rotary disks, or “blisks”, even if, for example, only one rotor is shown for the high-pressure turbine 5 and the low-pressure turbine 6, respectively, in the illustration in FIG. 1.

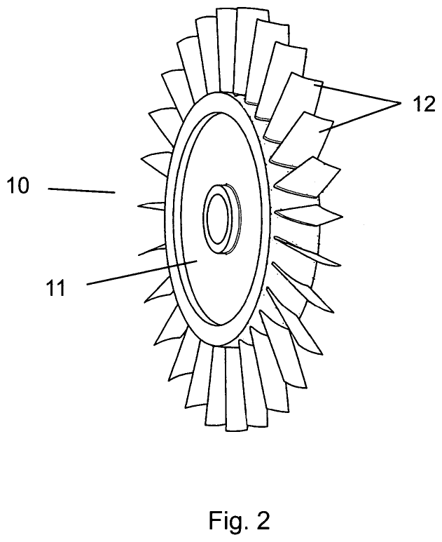

FIG. 2 shows a blisk 10 of the kind that can be used as the rotor of the high-pressure compressor 4 and/or of the low-pressure turbine 6 of the geared turbofan engine 1. The blisk 10 comprises a disk 11, on the outer circumference of which a multiplicity of rotor blades 12 are integrally arranged.

By means of the reduction gear 9, the low-pressure shaft 7 and thus the low-pressure turbine 6 or the low-pressure compressor 3 can be operated at a high rotational speed, and therefore the speed of movement of the blade tips of the rotor blades 12 of the low-pressure turbine 6 on the circular path of movement is high during operation. If the rotor is designed as a blisk 10, the material used for the blisk 10 must accordingly meet the requirements both as regards strength and, in particular, high-temperature strength and creep strength and as regards fatigue strength for the disk 11 and the rotor blades 12.

According to the invention, the material provided for the blisk 10 is a nickel base material which is marketed under the trade name Udimet U720 Li and has a composition which is 15.5 to 16.5% by weight chromium, 14 to 15.5% by weight cobalt, 4.75 to 5.25% by weight titanium, 2.75 to 3.25% by weight molybdenum, 2.25 to 2.75% by weight aluminum and 1 to 1.5% by weight tungsten and the remainder nickel and optionally 0.0250% by weight to 0.0500% by weight Zr and/or 0.0100% by weight to 0.0200% by weight B and/or 0.0100% by weight to 0.0200% by weight C. Such a material is outstandingly capable of meeting the high requirements placed on the disk material at the high rotational speed of a low-pressure turbine in a geared turbofan engine at the temperatures in the region of the low-pressure turbine, in which operating temperatures above 650° C. and, in particular, up to 720° C. are possible.

A blisk made from such a material can be produced, in particular, by a process in which, after the casting of an “ingot”, the material is firstly provided with a steel case and, first of all, is prepared for the further forming process by forging by what is known as conversion. In this process, the cast block is upset and marked out and forged to form a forging precursor material, the “billet”. After this, “mults” are sawn out of the billet, and these are upset and pierced. The semifinished products are then brought to a near net shape contour by drop forging or isothermal forging. Final machining is then carried out by electrical discharge machining or electrochemical machining.

Apart from the rotors for the low-pressure turbine 6 in the form of blisks, it is also possible in a corresponding manner to manufacture rotor disks for the arrangement of rotor blades for the low-pressure turbine 6, or rotors or parts thereof in the form of rotor disks for the high-pressure compressor.

Although the present invention has been described in detail with reference to the exemplary embodiments, it is self-evident to the person skilled in the art that the invention is not restricted to these exemplary embodiments but that, on the contrary, modifications are possible in such a way that individual features can be omitted or different combinations of features can be implemented without exceeding the scope of protection of the appended claims. In particular, the present disclosure includes all combinations of the individual features shown in the various exemplary embodiments, and therefore individual features which are described only in connection with one exemplary embodiment can also be used in other exemplary embodiments or combinations of individual features which are not explicitly described.

### LIST OF REFERENCE SIGNS

1 geared turbofan engine
2 fan
3 low-pressure compressor
4 high-pressure compressor
5 high-pressure turbine
6 low-pressure turbine
7 low-pressure shaft
8 high-pressure shaft
9 reduction gear
10 blisk
11 disk
12 blades

1.-9. (canceled)

10. A method for producing a rotary disk or a blisk for a high-pressure compressor or a high-speed turbine, wherein the method comprises providing a Ni base alloy comprising, in % by weight, from 15.5 to 16.5 Cr, from 14.0 to 15.5 Co, from 4.75 to 5.25 Ti, from 2.75 to 3.25 Mo, from 2.25 to 2.75 Al, from 1.00 to 1.50 W, optionally from 0.0250 to 0.0500 Zr, optionally from 0.0100 to 0.0200 B, optionally from 0.0100 to 0.0200 C, remainder Ni, the Ni base alloy being formed by forging to result in structure and a preform of the disk or blisk, a final contour of the disk or blisk being produced by electrical discharge machining or electrochemical machining.

11. The method of claim 10, wherein a rotary disk or a blisk for a low-pressure turbine of an aircraft engine is produced.

12. The method of claim 11, wherein a rotary disk or a blisk for a low-pressure turbine of a geared turbofan engine is produced.

13. The method of claim 11, wherein the rotary disk or blisk is designed and/or suitable and/or intended for an An²≥4,000 m²/s² in an Aerodynamic Design Point (ADP) range of the aircraft engine.

14. The method of claim 13, wherein An²≥4,500 m²/s².

15. The method of claim 13, wherein An²≥5,000 m²/s².

16. The method of claim 10, wherein the Ni base material comprises from 0.0250 to 0.0500 Zr.

17. The method of claim 10, wherein the Ni base material comprises from 0.0100 to 0.0200 B.

18. The method of claim 10, wherein the Ni base material comprises from 0.0100 to 0.0200 C.

19. The method of claim 10, wherein the Ni base material comprises from 0.0250 to 0.0500 Zr, from 0.0100 to 0.0200 B and from 0.0100 to 0.0200 C.

20. The method of claim 10, wherein the method further comprises providing the high-pressure compressor with a corrosion and/or erosion protection layer.

21. A geared turbofan engine for an aircraft having a fan, a shaft for driving the fan, a compressor and a turbine for driving the shaft and the compressor, wherein a reduction gear is arranged between the fan and the shaft, allowing the shaft to rotate at higher speeds than the fan, wherein the turbine is designed for an An²≥4,000 m²/s² in an ADP range of the aircraft engine and comprises at least one rotor having a rotary disk with turbine blades or at least one blisk capable of being operated at an operating temperature of at least 650° C., the rotary disk or blisk being manufactured from a Ni base material which comprises, in % by weight, from 15.5 to 16.5 Cr, from 14.0 to 15.5 Co, from 4.75 to 5.25 Ti, from 2.75 to 3.25 Mo, from 2.25 to 2.75 Al, from 1.00 to 1.50 W, optionally from 0.0250 to 0.0500 Zr, optionally from 0.0100 to 0.0200 B, optionally from 0.0100 to 0.0200 C, remainder Ni.

22. The geared turbofan engine of claim 21, wherein the turbine is designed for an An²≥4,500 m²/s².

23. The geared turbofan engine of claim 21, wherein the turbine is designed for an An²≥5,000 m²/s².

24. The geared turbofan engine of claim 21, wherein the Ni base material comprises from 0.0250 to 0.0500 Zr.

25. The geared turbofan engine of claim 21, wherein the Ni base material comprises from 0.0100 to 0.0200 B.

26. The geared turbofan engine of claim 21, wherein the Ni base material comprises from 0.0100 to 0.0200 C.

27. The geared turbofan engine of claim 21, wherein the Ni base material comprises from 0.0250 to 0.0500 Zr, from 0.0100 to 0.0200 B and from 0.0100 to 0.0200 C.

28. The geared turbofan engine of claim 21, wherein the at least one rotor having a rotary disk with turbine blades or at least one blisk is capable of being operated at an operating temperature of at least 700° C.

29. The geared turbofan engine of claim 21, wherein the at least one rotor having a rotary disk with turbine blades or at least one blisk is capable of being operated at an operating temperature of up to 720° C.
